(19) United States
(12) Patent Application Publication
(10) Pub. No.: US 2025/0102372 A1
(43) Pub. Date: Mar. 27, 2025

(54) TEMPERATURE MEASURING DEVICE WITH AN OPTICAL FIBER INSULATED FROM A FIXING WALL BY A PART COMPRISING CORK

(71) Applicant: Airbus Operations (S.A.S.), Toulouse (FR)

(72) Inventors: Laetitia MENNEBEUF, Toulouse (FR); Jean-Christophe COMBIER, Toulouse (FR); Serife DERGICI, Toulouse (FR)

(21) Appl. No.: 18/894,786

(22) Filed: Sep. 24, 2024

(30) Foreign Application Priority Data
Sep. 27, 2023 (FR) 2310265

(51) Int. Cl. G01K 11/32; G01K 1/08; G01K 13/02

(52) U.S. Cl. CPC G01K 11/32; G01K 1/08; G01K 13/028

(57) ABSTRACT

A device for measuring temperature of a fluid flowing over an outer wall of an object including an optical fiber and a flexible jacket surrounding the optical fiber, the optical fiber extending along a longitudinal axis, the measuring device including an elongate insulating part including cork and having at least two opposite faces, an inner face and an outer face, and the jacket surrounding the insulating part, apart from the outer face, and keeping the inner face of the insulating part facing the optical fiber over at least a part of its length along the longitudinal axis, the inner face of the insulating part having a transverse dimension greater at least than the diameter of the fiber.

### TECHNICAL FIELD

The disclosure herein relates to a measuring device that can be attached to an outer wall of a moving object or a fixed object located in a fluid flow for measuring physical quantities. More particularly, the disclosure herein applies to the measuring of parameters used to characterize a flow of air on the surface of an aircraft.

### BACKGROUND

During in-flight tests, sensors are mounted on the outer surface of an aircraft to perform different types of measurement. The study of the results makes it possible to understand the behavior of an aircraft in flight and to improve it or validate the performance levels. According to a particular application, it is possible for example to detect and locate aerodynamic phenomena on the aircraft.

The patent application EP4067827 describes a device for measuring a physical quantity such as a temperature, intended to be attached to a wall of a moving object or of a fixed object in a flow that is wanted to be characterized using the measured physical quantity. The device comprises a support having a face intended to come into contact with the wall and an opposite face, called free face, located in the flow. The support comprises recesses in which sensors are housed, the recesses being provided with an aperture opening into a cavity in which there is a flexible printed circuit on the side of the free face. The circuit is disposed upside down in the cavity, the sensors fixed to the circuit being located suspended in the recesses. The sensors thus make it possible to measure the temperature of the air stream which flows along the wall to which the measuring device is fixed.

When the support is applied to an engine wall, the temperature can be very high and disturb the measurement of the temperature of the stream flowing along the wall by the sensor suspended above the wall.

### SUMMARY

The disclosure herein aims to propose a novel architecture of a flow temperature measuring device that makes it possible to mitigate this drawback.

To this end, the disclosure herein relates to a device for measuring the temperature of a fluid flowing over an outer wall of an object comprising an optical fiber and a flexible jacket surrounding the optical fiber, the optical fiber extending along a longitudinal axis X, wherein the measuring device comprises an elongate insulating part comprising cork and having at least two opposite faces, an inner face and an outer face, and wherein the jacket surrounds the insulating part, apart from the outer face, and keeps the inner face of the insulating part facing the optical fiber over at least a part of its length along the longitudinal axis X, the inner face of the insulating part having a transverse dimension greater at least than the diameter of the fiber.

The disclosure herein provides at least one of the following optional features, taken alone or in combination.

The inner and outer faces of the insulating part are coated at least partially with a layer of silicone elastomer, the insulating part then being called insulating part with seals.

The fiber is coated with a sheath and called sheathed fiber, the jacket surrounding the sheathed fiber and the insulating part with seals, apart from the outer face coated at least partially with silicone elastomer.

The sheathed fiber is in contact with the insulating part with seals over the entire length of the insulating part.

The jacket has a polyhedral form with six faces comprising at least two flat parallel faces, including one with an open cavity of a form complementing the insulating part with seals.

The thickness of the jacket between the two flat parallel faces at the sheathed fiber corresponds substantially to the diameter of the sheathed fiber, or is even slightly greater.

The insulating part is a sheet of natural or expanded cork.

The jacket has a trapezoidal section, the jacket, the insulating part with seals and the sheathed fiber having a form that is symmetrical with respect to a plane P passing through the longitudinal axis X, the sheathed fiber being positioned on the insulating part with seals at the plane.

The disclosure herein relates also to a structure comprising a wall provided with a measuring device having at least one or more of the above features, and to the aircraft comprising such a structure.

### BRIEF DESCRIPTION OF THE DRAWINGS

Other aims, features and advantages will emerge from the following description of the disclosure herein, a description given purely as a nonlimiting example, with reference to the attached drawings in which:

FIG. 1 is a perspective schematic view of an aircraft that can be provided with the measuring device according to the disclosure herein;

FIG. 2 is a perspective schematic view of an aircraft propulsive assembly provided with a measuring device according to the disclosure herein; and

FIG. 3 is a side cross-sectional view of a measuring device attached to a wall of an object according to the disclosure herein.

### DETAILED DESCRIPTION

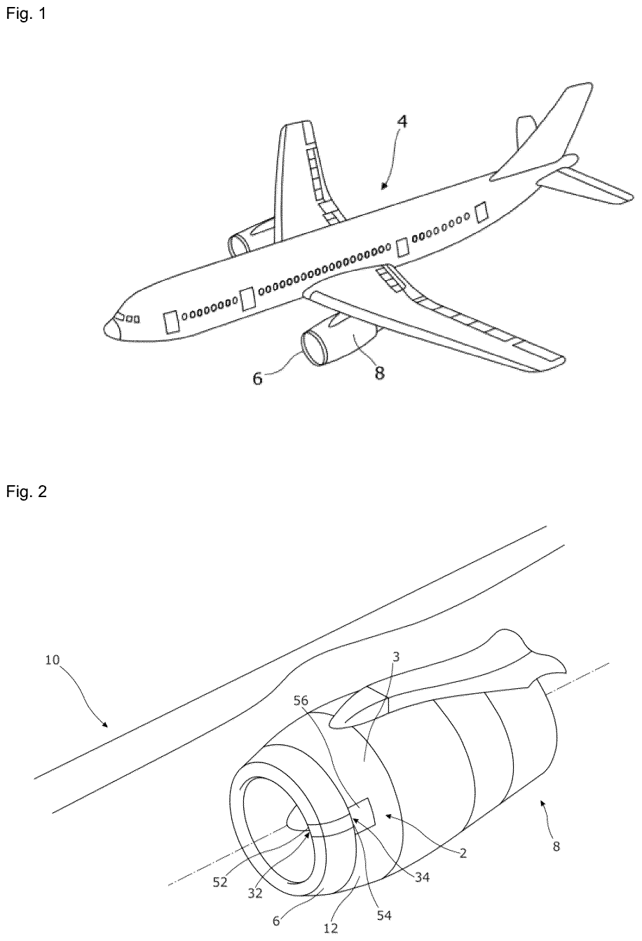

The measuring device 2 according to the disclosure herein equips a structure 3 and, according to an application illustrated in FIGS. 1 to 3, a determined structure 3 of an aircraft 4, namely, more particularly, a nacelle 6 of a power plant 8 in the context of in-flight tests. The disclosure herein relates to a device 2 for measuring the temperature of an air stream 10 flowing along the outer wall 12 of the nacelle 6 and schematically represented by two stream lines illustrated in FIG. 2. Any other application of the device on an outer wall 12 of a moving object such as an aircraft 4 or of a fixed object located in a fluid flow for measuring its temperature can be envisaged.

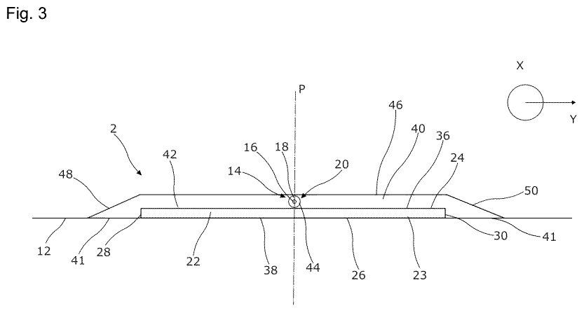

As represented in FIG. 3, the measuring device 2 comprises a sensor 14 intended to measure the temperature of the stream 10. In order to allow the temperature of the stream 10 to be measured, the sensor 14 must be fixed to the wall 12 of the nacelle 6. The sensor is an optical fiber 16, the operation of which is of known type and will not be described in more detail. The optical fiber has the advantage of withstanding the high temperatures inherent to the nacelles 6 and of being flexible to follow the outlines thereof. It also has the advantage of being of little bulk and lightweight. It makes it possible, by its possible length, to be applied to objects of large size like the nacelle. It offers high measurement speed and accuracy. The optical fiber can measure physical quantities such as the temperature of the air stream flowing along the wall of the object to which it is attached, namely, in the application retained, the temperature of the stream flowing along the outer wall 12 of the nacelle. It offers the possibility of a multiplicity of measurements over all or part of its length. The fiber 16 is coated with a flexible sheath 18, for example made of polytetrafluoroethylene, also called PTFE, offering resistance to high temperatures. The sheath 18 completely surrounds the fiber 16 and has the form of a sleeve. The fiber 16 coated with the sheath 18 will hereinafter in the description be designated sheathed fiber 20. The sheath 18 could be made of any other type of material suited to the environment, such as, for example, polyetheretherketone, also called PEEK, glass fiber-reinforced polyamide or even metal. The sheathed fiber extends along a longitudinal axis X.

The sheathed fiber 20 is placed in the air stream 10 and it is insulated from the high temperatures given off by the wall 12 of the nacelle via an insulating part 22 comprising cork. The insulating part 22 has an elongate form extending along the sheathed fiber 20 between the latter and the wall 12 of the object, here the nacelle. The insulating part 22 comprises at least two opposite faces 24, 26, a so-called inner face 24 located on the side of the sheathed fiber, the other so-called outer face 26 being located on the opposite side. The insulating part is kept facing the optical fiber over at least a part of the length of the fiber and, in the form illustrated, over its entire length. The inner face 24 of the insulating part 22 has a transverse dimension, namely at right angles to the longitudinal axis X, greater at least than the diameter of the fiber and, in the form illustrated, greater than the diameter of the sheathed fiber over the entire length along the axis X thereof. Cork is a very good thermal insulator which has the additional advantage of being lightweight and easy to handle, of allowing a robust fixing in light of the environment of the measuring device when the aircraft is in flight. More specifically, the material can be natural cork, expanded cork, or even, for example, a combination of cork and of another material providing additional technical advantages. It can for example be rubber: rubber adds an impermeability and allows the measuring device to a little more closely follow the form of the wall against which it is applied. In the form illustrated, the insulating part 22 is entirely made of cork, natural or expanded.

In the form illustrated in FIG. 3, the insulating part 22 comprising cork takes the form of a sheet: it has a parallelepiped form of rectangular section having six faces, but any other form is possible as long as it allows it to be inserted between the sheathed fiber 20 and the wall 12 of the object, here the nacelle of the aircraft, and thus to thermally insulate the fiber from the wall 12. The length of the part 22 is preferably equal to or greater than the length of the fiber. The thickness and the width of the part 22 are determined so as to ensure a sufficient insulation while offering a reduced bulk and depend on the environment and on the materials used. The width of the part 22 in sheet form is greater than the diameter of the sheathed fiber. In the example illustrated, the insulating part 22 has two parallel longitudinal faces, one of them the so-called inner face 24 being that on which the fiber rests on a central longitudinal axis X, the other so-called outer face 26 being the parallel longitudinal face opposite thereto. The longitudinal faces 28, 30 linking the inner and outer faces are called lateral longitudinal faces. The transverse faces 32, 34 of the part 22 not visible in FIG. 2 but the positioning of which is indicated by arrows are the last two faces of the six faces of the sheet 22. They are parallel to one another but could be not parallel.

As illustrated in FIG. 3, seal layers 36, 38 are applied at least partially to at least two faces, respectively 24, 26, of the insulating part 22, one of which is intended to be fixed with the wall 12. In the example illustrated, the insulating part 22 is sandwiched between two seal layers 36, 38. The seal layers 36, 38 can be made of silicone elastomer, for example of RTV (Room Temperature Vulcanization) 106 type. The seal layer 38 makes it possible to improve the fixing of the insulating part 22 containing cork to the wall 12. The use of an RTV silicone elastomer also makes it possible to withstand high temperatures while additionally making it possible to insulate the sheathed fiber against the vibrations. Each layer 36, 38 is applied to a part or all of the surface of the inner and outer longitudinal faces 24, 26 of the insulating part 22. In the embodiment described as an example, each layer 36, 38 entirely coats the faces respectively 24, 26 of the part 22. The insulating part 22 coated with the seal layers 36, 38 will hereinafter be called insulating part with seals 23.

The sheathed fiber 20 is positioned on and along the insulating part with seals 23. The sheathed fiber 20 and the insulating part 23 with seals, apart from its face 26 coated with the layer 38 intended to be fixed to the wall 12, are jacketed with a jacket 40. The jacket 40 makes it possible to keep them against one another. In the form illustrated, the jacket keeps the inner face 24 of the insulating part facing the fiber over its entire length along the longitudinal axis X, the sheathed fiber being in contact with the insulating part over at least a part and, in the form illustrated, over the entire length of the insulating part. According to another possible form, the sheathed fiber could be separated from the insulating part with seals by the jacket. The face 26 that is left free makes it possible, via the seal layer 38 as seen previously, to improve the fixing to the wall 12 of the nacelle. Preferably, the thickness of the jacket 40 on the sheathed fiber is such that the sheathed fiber is as close as possible to the air stream 10 so as to measure the temperature thereof more accurately while being held by the jacket 40. Thus, as FIG. 3 shows, in the embodiment illustrated, in the transverse cross-section and the central longitudinal plane P of symmetry of the sheathed fiber and of the jacket, the thickness of the jacket 40 substantially matches the thickness of the sheathed fiber, or is even slightly greater, to ensure a continuity of surface of the jacket. Moreover, the layer 36 on the inner face 24 of the insulating part 22 makes it possible to facilitate the fixing of the insulating part with seals 23 to the jacket 40. The layer 38 and the jacket 40 on its face 41 intended to be attached to the wall 12 have surfaces that are flush with one another, forming one and the same surface intended to be attached to the wall of the nacelle.

The main function of the jacket 40 is to offer a fairing to the sensor 14, which is, in the example illustrated, the sheathed fiber 20, and to the insulating part 23 with seals, in order to protect them from any type of outside aggressions (impacts of objects, of birds or other things against the air intake, bad weather or any other type of aggressions). The sheathed fiber 20 and the insulating part 23 with seals are embedded in the jacket 40 (apart from the layer 38 as seen above). In the example described, the sheathed fiber 20 is in contact with the insulating part 23 with seals but they could be separated by the jacket, both embedded inside. The flexible jacket 40 can be produced in polymer material, for example in polyurethane or silicone or a compound of any other type of material that is flexible enough to closely follow the outlines of the wall 12 and that makes it possible to protect the sheathed fiber and to withstand the high temperatures of the environment. It can be produced by moulding, machining or any other known type of manufacturing method.

The flexible jacket 40 can be produced in polymer material, for example in polyurethane or silicone or a compound of any other type of material that is flexible enough to closely follow the outlines of the aircraft and that makes it possible to protect the sheathed fiber and to withstand the high temperatures of the environment. It can be produced by moulding, machining or any other known type of manufacturing method.

In the embodiment illustrated in FIG. 3, the jacket 40 has an outer overall polyhedral form with 6 faces having two cavities 42, 44, one open cavity 42 of a form complementing the insulating part 23 with seals and one cavity 44 of a form complementing the sheathed fiber. The 6 faces of the jacket are as follows:—the face 41 intended to come into contact with the wall 12 of the nacelle flush with the surface of the layer 38 intended to come into contact with the wall 12 (as seen previously), the cavity 42 of a form complementing the insulating part 23 with seals opening in the face 41. Thus, the part 23 inside the cavity 42 is incorporated in the jacket 40. It is jacketed apart from its face 26 coated with the layer 38 forming, with the face 41 of the jacket, one and the same surface, allowing the fixing to the wall 12;—a free second face 46, parallel and opposite to the first face 41;—two faces 48, 50 forming the longitudinal lateral edges of the jacket. The lateral edges of the jacket have a decreasing thickness tapering towards the periphery making it possible to offer a surface that only very weakly disturbs the aerodynamic flow;—two faces 52, 54 (visible in FIG. 2), forming the transverse ends of the jacket, one of them 54 being intended to be connected to a measured data management unit 56, the other 52 corresponding to the free transverse end of the jacket. The profile of the section of the jacket illustrated in FIG. 3 is trapezoidal. The jacket, the insulating part with seals and the sheathed fiber have a form that is symmetrical with respect to a plane P passing through the longitudinal axis X, the sheathed fiber being positioned on the insulating part with seals at the plane. As indicated above, the jacket 40 can have any type of form: thus, the free transverse face 52 forming one of the longitudinal ends of the jacket can have a decreasing thickness tapering towards the longitudinal side opposite to the unit 56 making it possible to offer, in the same way as the two faces 48, 50 of the jacket, a surface that disturbs the aerodynamic flow as weakly as possible. The face 52 is then in this case inclined and not at right angles to the faces 41 and 46.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A device for measuring a temperature of a fluid flowing over an outer wall of an object comprising an optical fiber and a flexible jacket surrounding the optical fiber, the optical fiber extending along a longitudinal axis, wherein the measuring device comprises an elongate insulating part comprising cork and having at least two opposite faces, an inner face and an outer face, and wherein the jacket surrounds the insulating part, apart from the outer face, and keeps the inner face of the insulating part facing the optical fiber over at least a part of its length along the longitudinal axis, the inner face of the insulating part having a transverse dimension greater at least than a diameter of the fiber.

2. The measuring device according to claim 1, wherein the inner and outer faces of the insulating part are coated at least partially with a layer, respectively, of silicone elastomer, the insulating part then being an insulating part with seals.

3. The measuring device according to claim 2, wherein the fiber is coated with a sheath to be a sheathed fiber, the jacket surrounding the sheathed fiber and the insulating part with seals, apart from the outer face coated at least partially with silicone elastomer.

4. The measuring device according to claim 3, wherein the sheathed fiber is in contact with the insulating part with seals over an entire length of the insulating part with seals.

5. The measuring device according to claim 2, wherein the jacket has a polyhedral form with six faces comprising at least two flat parallel faces, including one with an open cavity of a form complementing the insulating part with seals.

6. The measuring device according to claim 3, wherein a thickness of the jacket between the two faces at the sheathed fiber corresponds substantially to a diameter of the sheathed fiber, or is even slightly greater.

7. The measuring device according to claim 1, wherein the insulating part is a sheet of natural or expanded cork.

8. The measuring device according to claim 3, wherein the jacket has a trapezoidal section, the jacket, the insulating part with seals and the sheathed fiber having a form that is symmetrical with respect to a plane passing through the longitudinal axis, the sheathed fiber being positioned on the insulating part with seals at the plane.

9. A structure having a wall comprising the measuring device according to claim 1.

10. An aircraft comprising the structure according to claim 9.
